(19) United States
(12) Patent Application Publication
(10) Pub. No.: US 2005/0273511 A1
(43) Pub. Date: Dec. 8, 2005

(54) Equitable resource sharing in grid-based computing environments

(75) Inventors: Nazareno Ferreira de Andrade, Jaguaribe Joao Pessoa (BR); Walfredo Cirne Filho, Campina Grande (BR); Franscisco Vilar Brasileiro, Campina Grande (BR); Paulo Roisenberg, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/862,444

(22) Filed: Jun. 8, 2004

(51) Int. Cl. G06F 15/16

(52) U.S. Cl. 709/227

(57) ABSTRACT

The invention relates to a method of allocating grid-based computer resources which is based on an exchange model that is predicated exclusively on a system of returned favours. A favour is defined as the act of offering a resource and the method is performed in respect of two or more grid resource providers/consumers which are alternatively known as participants. In one embodiment, the method includes the steps of establishing two or more participants in a grid-based computer system where at least one of said participants offers resources. Each participant expects resources to be offered in return in proportion to the level of resources which that participant offers. Primarily, the present invention may be applied in arbitration situations whereby a participant which is offering resources arbitrates conflicting requests for its resources by prioritizing requests from those other participants who have offered favours in the past. The invention may be applied most suitably in the context of applications which can be run in a fragmentary task fashion where each task may be executed independently of each other task comprising the whole application. Specific computational contexts to which the invention may be applied include large-scale computationally intensive calculations such as molecular modeling, analysis of large bodies of data and the like. The invention may be applied to similar evanescent grid-based computer resources such as network storage and similar.

### TECHNICAL FIELD

The present invention relates to methods and apparatus for allocating and sharing resources in grid-based computing systems. More particularly, although not exclusively, the invention relates to methods and apparatus for resolving resource contention in a peer-to-peer grid network.

### BACKGROUND ART

Computational grids are constructs which allow the sharing and aggregation of a large variety of potentially geographically distributed computational resources having disparate abilities and characteristics. Examples of such resources include clusters, supercomputers, storage systems, data sources and people.

The aim of the computational grid paradigm is to present these disparate resources as a single unified resource capable of processing large-scale, computationally intensive applications. Examples of some applications which are considered highly suitable for grid-based processing include molecular modeling, radio-telescope data analysis (for example, the SETI project (http://setiathome.ssl.berkeley.edu/)) and the analysis of high energy particle physics data. These applications share the common attributes that they involve often immense amounts of raw data and that they are capable of being broken down into sub-tasks. As will be discussed below, this latter aspect makes such calculations particularly suitable for distributed computing environments.

A workable grid-based computing system is constituted by accessing a number of grid resources. This poses a difficulty in that in order to access a geographically dispersed network of disparate resources, a user needs to negotiate and obtain permission from each resources owner. In a local grid, such as within a computing lab in a university, this may not be a problem as communicating such a request may be as simple as personally requesting the desired access. However, in the more likely situations where the grid crosses institutional or perhaps national boundaries, the situation may become untenable.

Also, one ideal of grid-based computing is that computing power should be distributed as a utility, for example in a manner similar to electrical power. To this end, the user should be able to use the computing resources without being aware of the supplier, location or possibly even the hardware involved in the particular task. A corollary to this philosophy is that many users are likely to request resources simultaneously; therefore there must be a mechanism for dealing with and arbitrating conflicting resource requests.

In some respects, the provision of distributed computing resources is analogous to a supply and demand problem and it is therefore known to approach this issue using economic models from real markets. However, in distributed computing this poses a difficulty in that there is as yet no reliable infrastructure which allows users to verify what computing resources they have consumed and how they are to pay for them. For such an approach to be successful, it is necessary that secure economic financial transaction technologies be available. In the absence of such mechanisms, some other means for carrying out grid resource request allocation and arbitration are needed.

To the present time, most of the initiatives in this field have been devoted to mechanisms that support static access policies and constraints to allow metacomputing infrastructures to be created across different administrative domains. An example of this approach is the Condor System (Thain, Tannenbaum and Livny, “Grid Computing: Making the Global Infrastructure a Reality” Wiley, 2003, also see http://grid202.org) and the Computational Co-op (Cirne and Marzullo, “The Computational Co-op: Gathering Clusters into a Metacomputer”, PPS/SPDP'99 Symposium (1999).

The Condor system uses different mechanisms to allow a user access to resources across institutional boundaries. These mechanisms include institutional-level agreements and user-to-institution agreements. Condor has, however, not dealt with dynamic access provision.

The Computational Co-op implemented a mechanism for aggregating sites in a grid using cooperatives as a metaphor. This approach allows the sites to control how much of their resources are to be offered for grid use and was implemented using a proportional-share ticket-based scheduler. The tickets are used by users to access local and grid resources, obtaining priorities as they spend the tickets. However, the need for negotiation between the owners of the sites and the division of the grid tickets as well as the non-transfer of tickets renders the Co-op too inflexible to function as a grid with dynamically allocated resources. Further, the Co-op systems depends on a robust cryptography infrastructure to ensure the authenticity of the tickets.

A more recent effort related to access provision in grid computing environments includes research on grid economy known as the Grid Architecture or Computational Economy (GRACE—Buyya, Abramson and Giddy “An Economy Driven Resource Management Architecture for Computational Power Grids”, International Conference on Parallel and Distributed Processing Techniques and Applications (2000)).

The GRACE is an abstract architecture that supports different economic models for negotiating access to grid resources. Nimrod/G (Abramson, Buyya & Giddy “A computational economy for grid computing and its implementation in the Nimrod-G resource broker” Future Generation Computer Systems, (FGCS) Journal 18 (2002)), is a grid broker that implements GRACE concepts, allowing a grid client to negotiate access to resources and pay for it. Also, the Compute Power Market (Buyya & Vazhkudai “Compute Power Market: Towards a Market-Oriented Grid” 1^{st} IEEE/ACM International Symposium on Cluster Computing and the Grid (CCGrid 2001)), aims to provide access to resources in a decentralized manner through a peer-to-peer network, letting users pay in cash for using grid resources. Again however in order to implement these approaches it is necessary to deploy an infrastructure capable of secure negotiation, payment and banking. Again, the maturity of these financial transaction systems is presently considered inadequate, thus deferring the implementation of economic-based approaches as viable systems.

Thus, there exists a need for a negotiation approach which provides a mechanism of dynamically carrying out resource request, allocation and, where necessary, arbitration. It is an object of the present invention to provide such a mechanism.

### DISCLOSURE OF THE INVENTION

In one aspect, the invention provides for a method of allocating computer resources based on an exchange model exclusively of returned favours.

In a preferred embodiment, the computer resources correspond to those which are evanescent such as grid-computing resources, network storage resources or the like.

A favour may be defined as the act of offering a resource.

The method preferably is performed in respect of two or more grid resource providers/consumers, alternatively known as participants.

In a preferred aspect, the invention provides for a method of allocating grid-based computer resources comprising the steps of:
establishing two or more participants in a grid-based computer system, at least one of said participants offering resources; wherein, each participant expects resources to be offered in return in proportion to the level of resources which that participant offers.

In a preferred embodiment, each participant benefits in proportion to the number of favours it provides to other participants.

The method preferably provides for a means by which a participant offering resources can arbitrate conflicting requests for that participants' resources by prioritizing requests from those other participants who have offered favours in the past.

The step of request prioritization may be performed subject to local policies, these being preferably governed by characteristics of the participant offering the resources.

Preferably, the process of requesting a resources comprises the steps of a consumer making a request for resources by broadcasting to a peer-to-peer network the characteristics of the desired resources which correspond to the task to be executed; providers with matching and available resources replying to the requestor, potentially in accordance with local policies of the provider, wherein the set of replies from the providers instantiate the grid which is thereby made available in response to the consumers request.

A participant may correspond to a group of discrete participants logically aggregated for the purpose of offering specified resources.

The aggregation may be imposed by factors such as physical collocation, administrative control of the discrete participants, homogeneity in participant capability and the like.

The participants preferably correspond to peers in a peer-to-peer system, the system operating in accordance with the method as defined above.

Each peer preferably maintains a record of the resources previously offered by each other known peer, thereby allowing each peer to prioritise other known peers when arbitrating conflicting requests for resources.

Thus a peer will prioritise peers who have provided favours in the past and marginalise peers who do not return favours.

Preferably, any available and idle resources are available to any user where there is no contention for those resources.

In a further aspect, the invention provides for a network comprising a plurality of peers, each peer configured to offer and/or consume grid-based computer resources based on an exchange model exclusively of returned favours.

### BRIEF DESCRIPTION OF THE DRAWINGS

The present invention will now be described by way of example only and with reference to the drawings in which:

FIG. 1: illustrates a simplified schematic of a network architecture according to one embodiment of the invention;

FIG. 2: illustrates the dual nature of each peer, as a consumer and as a provider;

FIG. 3: illustrates a sequence diagram for the interaction illustrated in FIG. 3;

FIG. 4: illustrates a providers allocator method; and

FIG. 5: illustrates a consumers remote executor method.

### BEST MODE FOR CARRYING OUT THE INVENTION

As a preliminary note, the prototype embodiment of the present invention is referred to as the “OurGrid” approach. This nomenclature will be used in the following description where appropriate.

OurGrid is based on a model of resource sharing that is intended to provide equity with a minimum of required or implied guarantees. The intention is to provide an extensible and easy to install platform particularly suitable for running a set of grid applications. It is a requirement that at least some of the participants are willing to share their resources in order to obtain access to the grid. The invention is particularly suitable for providing grid-based computing resources to a class of applications known as “bag of tasks” (BoT) applications. However this is not necessarily a limiting type of possible application. Monolithic application execution may be possible given a specifically tailored task/application scheduler.

BoT applications are parallel applications composed of a set of independent tasks that require no inter-process communication during execution. A number of classes of numerical calculation satisfy this context such as those in the fields of computational biology, simulations and imaging.

The network architecture of an exemplary embodiment of the invention is described as follows.

A user accesses the grid via a peer. The peer maintains communication with other peers using community-level services such as application level routing and discovery. The peer acts as a grid broker in respect of its users.

A peer P can be accessed by native and foreign users. Native users are those who access grid resources through P, while foreign users have access to Ps resources via other peers. Thus a peer is both a consumer and provider of resources. When a peer P provides a service, i.e., it makes a favour in response to a request from a peer Q, P is acting as a provider of resources to Q, while Q is acting as a consumer of Ps resources.

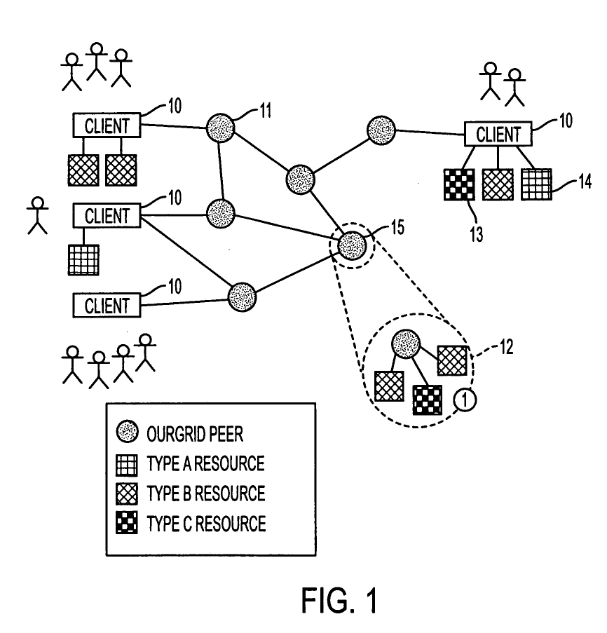

Referring to FIG. 1, a network architecture corresponding to an exemplary embodiment of the invention is shown. Like numerals refer to like components. Clients 10 correspond to software used by users to access the community resources. A client 10 is at least an application scheduler and may have additional functionality. Examples of suitable clients include MyGrid or Nimrod/G clients as discussed above.

Different resource types are anticipated. Referring to FIG. 1, resources 12 of type A could be clusters of workstations, type B resources 14 may be parallel supercomputers and type C resources 13 could be workstations running a specific type of agent software such as the MyGrid client.

FIG. 1 also shows that resources of variable granularity can be encapsulated within an OurGrid peer 12. Here, a peer embodies all three types of resource and as such are managed as an aggregate resource accessible via the peer 15. Given that resources are often grouped at physical or administratively considered aggregations or sites, this level of granularity can be leveraged to provide particular advantages. For example, as the number of peers reduces, search performance improves with respect to resource discovery and the systems topology starts to approximate its network infrastructure topology thereby alleviating traffic problems found in other peer-to-peer systems. In this situation, the system starts to mirror the real ownership distribution of the resources as they are grouped physically at a site, each with its corresponding set of users and owners.

It is also noted that a grid operating in accordance with the invention, referred to as an OurGrid community, can itself form a part of a larger set of resources which a user may have access to. Here users can be native users of more than one peer, either in the same or in different communities.

All resources are shared in what is known as a “network of favours”. According to this model, the act of allocating a resource to a requesting consumer constitutes a favour. It is expected that a consumer will become indebted to the owner of the consumed resource; this indebtedness being tracked by the local balance maintained by each peer in respect of it's the peers known to it.

The invention is predicated upon the expectation that participants in the network will return favours they are indebted to, when solicited. If a participant is perceived to be violating this axiom, that peer is gradually reduced in prioritization as its consumption accumulates and debts grow.

Every peer in the system keeps track of a local balance for each known peer based on their past interactions. This balance is used to prioritize peers when arbitrating conflicting requests. That is, for a peer P, all consumption of the resources of P by another peer P′ is debited from the balance for P′ in P and all resources provided by P′ to P is credited in the balance P maintains for P′. With all known peers' balances, each participant can maintain a ranking of all known participants. This ranking is updated on the execution of every consumed or provided favour.

Negotiation and agreement processes are not used globally, and the quantification of each favours value may be done locally and may serve only to effect the future resource allocations of the local peer.

As the peers in the system ask each other for resources, they gradually discover which participants are able to return their favours, and prioritise them, based on their debt or credit. Thus, a participant will prioritise helpful peers and marginalise peers who do not return favours satisfactorily. Non-retribution of favours can occur for many reasons such as failures on services or the communication network, absence of the desired service on the peer or a request failure due to contention with a more favoured peer.

An extreme example of this is a “free-rider” peer who may not return any favours at all. In this situation, such a peer will experience a gradual diminishing level of access to grid resources.

This highlights one of the primary intentions of the invention, namely to provide a mechanism for resolving conflicts as well as providing emergent behaviour which reflect equitable and efficient use of all of the potential resources in a grid-based computational system. To this end, available and idle resources are available to any user, although this may be varied in response to local site/aggregate policies.

Thus, an ordinary user can potentially access any resource on the grid. Further, any user who contributes little or no resources to the OurGrid community can still access the resources of the system but only if no other peer that has more credit requests use of those resources thereby producing a contention situation.

The use of idle resources by peers that do not contribute maximizes the theoretical utilization of the resources and does not harm the peers who have contributed with their resources. Fundamentally, unused computational cycles are evanescent, that is, they are wasted if not used. Therefore, in the absence of any form of negotiation model which might be applied to resource provision, the present invention represents a highly efficient and flexible way of distributing resources.

It is also noted that at a grid level of aggregation, the OurGrid system is completely decentralized and is composed of autonomous entities. Each peer depends only on its local knowledge and decisions in order to be part of the system. This characteristic greatly improves the adaptability and robustness of the invention as it does not depend on coordinated process or a global view of the grid.

Aspects of the resource sharing protocol will now be described.

To communicate with the OurGrid community, obtain access, consume and offer resources, all peers use a resource sharing protocol. Specifically, this protocol is concerned only with resource sharing in the peer-to-peer network. The system may of course use lower-level protocols relating to other necessary services such as peer discovery etc and these are distinguished from the sharing protocol described as follows.

The three participants in the resource sharing protocol are clients, consumers and providers. A client is a program that manages access to grid resources and runs application tasks on those resources. The OurGrid can be considered as such a resource, transparently offering services to a client. Thus, a client may access both OurGrid peers and other resources directly and access several OurGrid peers from different resource sharing communities. It is noted that the client may incorporate the application scheduler and any other domain-specific modules that are required to schedule an application efficiently.

A consumer is part of a peer which receives requests from a users client to find resources. The consumer is first used to request resources in respect of providers that are able and willing to provide favours, and, after obtaining then, execute tasks on the resources. Providers are the part of the peer which manage the resources shared in the community and provide them to consumers.

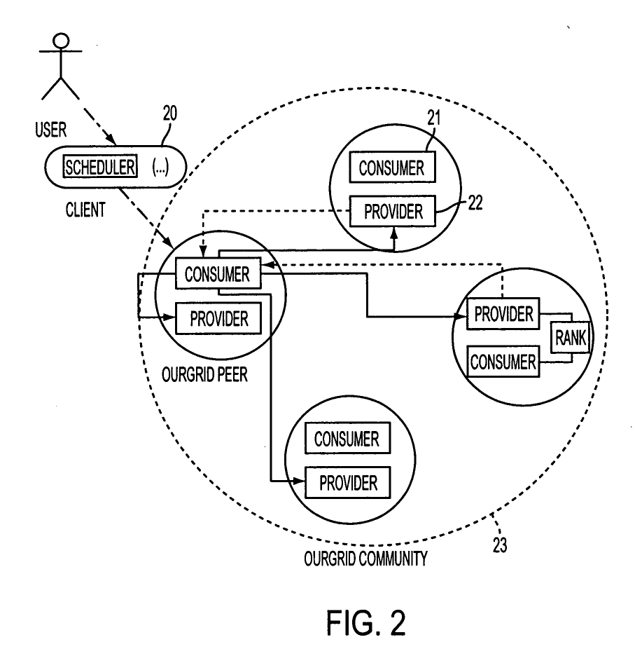

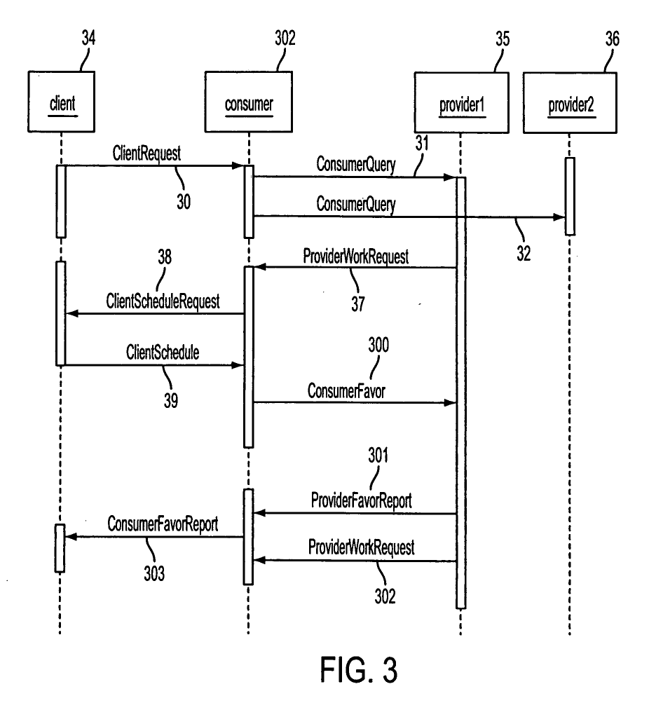

Referring to FIG. 2, every peer in the community has both a consumer 21 and a provider 22 module. Referring to FIG. 3, when a consumer receives a request for resources 30 from a local user's client 34, it broadcasts to the peer-to-peer network the desired resources characteristics in a ConsumerQuery message (31, 32). The resources characteristics correspond to the minimum requirements that are needed to execute the tasks that the ConsumerQuery message (31, 32) is referring to. It is the responsibility of the client 34 to discover this characteristic, possibly querying the user for this information.

As it is broadcasted, the ConsumerQuery message (31, 32) also reaches the provider 35 that belongs to the same peer as the consumer.

All providers 35 with matching and available resources reply (37) to the requester. This may be done according to the local policies of the provider. The set of replies up to a specified time defines the grid that has been made available by the OurGrid community, in response to the clients request. This set is dynamic as replies can arrive later, this corresponding to resources becoming available at more providers.

With the set of available resources, it is possible for the consumer peer to ask for its client to schedule tasks on them. This is done by sending a ConsumerScheduleRequest message (not shown) containing all known available providers.

It is noted that the application scheduling step is not within the scope of the invention and the user may select from existing scheduling algorithms. Once the client has scheduled a specified number of tasks to schedule on the one or more of the providers who sent ProviderWorkRequest messages 37, it sends a ClientSchedule message 39 to the consumer from which it requested the resources. As each peer represents a site, owning a set of resources, the ClientSchedule message 39 can contain either a list of ordered pairs (task provider) or a list of tuples (task, provider, processor). The client 34 decides how to format its ClientSchedule message 39. All tasks are sent through the consumer 302 and not directly from the client 34 to the provider, to allow the consumer 302 to account for its resource consumption.

The consumer then sends a ConsumerFavour message 300 to each provider Pₙ in the ClientSchedule message. This contains the tasks to be executed in Pₙ with all the data deeded to run it. If the peer who received the ConsumerFavour message 300 finished its tasks successfully, it then sends back a ProviderFavourReport message 301 to the corresponding consumer 302. After concluding the execution of each task, the provider (35, 36) also updates its local rank of known peers by subtracting a corresponding measure relates to the task execution cost from the consumer peers balance. The consumer peer 302, on receiving the ProviderFavourReport 301, also updates its local rank, but does this by adding the amount corresponding to the task execution cost to the provider balance. The consumer 302 may either trust the accounting sent by the provider or make its own autonomous accounting.

During the period that a provider has available resources that match the requests constraints and is willing to provide favours, it keeps asking the consumer for tasks. A provider may decide not to continue providing favours to a consumer in order to prioritise another requestor who has a higher ranking/priority.

Note that, after the first broadcast, the flow of requests is from the providers (35, 36) to the consumers 302. As the ProviderWordRequest messages 37 are the signal of availability, the consumer is alleviated from the task of managing the state of its current providers.

In the example shown in FIG. 3, Provider_{—}1, provides a favour to consumer, but provider_{—}2 is either unable or has decided not to provide any resources to consumer.

The invention may potentially implement different algorithms and implementations in respect of the peers and as such it is envisaged that a number of possible provider and consumer behaviour metrics are feasible. The following examples are intended to be exemplary only and are included to fully illustrate a preferred implementation of the invention.

A typical provider runs three threads: the receiver, the allocator and the executor. The receiver and the allocator run continuously. Both of them access, add, remove and alter elements of the list of received requests and of known peers. The executor is instantiated by the allocator to take care of the execution and accounting in respect of individual tasks. The receiver thread constantly checks for received requests and for any request, it checks that the sharing policies of the peer can accommodate any requests it may receive. If a request can be satisfied, the receiver adds it to the list of received requests. Two lists are maintained, one for requests issued by local users and one for requests issued by foreign users. This allows requests to be prioritised on the basis of requests made to local resources.

While executing, the allocator thread continuously attempts to satisfy the requests with any resources which may be available. If no resource is available, it asks for resources from the community.

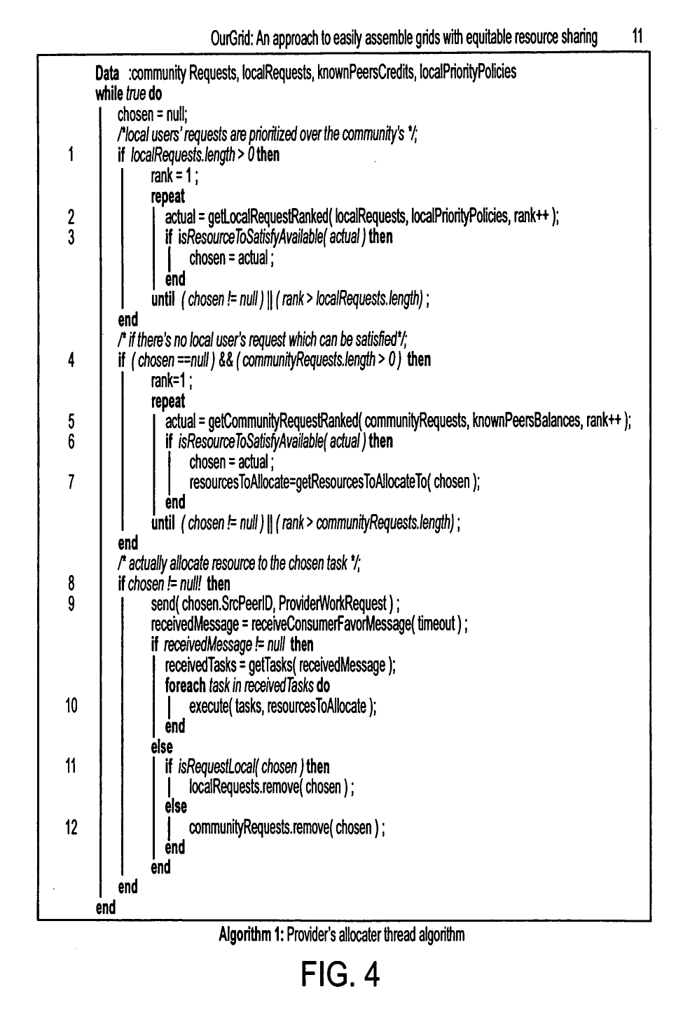

The allocator thread procedure is shown in FIG. 4. At line 2, the function getLocalRequest( ) returns the request with the specified positions in the priority ranking according to a local set of policies. The policies can differ from peer to peer, however examples of suitable policies may include FIFO or a policy based on prioritizing user who consumed less in the past. The function getCommunityRequestRanked( ) at line 5 performs the same function but with any community requests. This is based on the known peer balances which serves to prioritise these requests.

At lines 3 and 6, the allocator checks if the necessary resources are available according to local availability policies. If a particular request was selected to be answered in this iteration of the main loop, the allocator decides which resources will be allocated to this request and sends a message asking for the tasks to execute.

If it receives tasks to execute, the received tasks are then scheduled to run on resources allocated to that request. This is performed by the execute( ) function which creates a provider thread for each task that is to be executed. This may involve actions related to characteristics governed by local policies; for example the creation of directories having specified read/write user permissions.

After the task has been executed and its results collected and returned, the executor updates the credit of the consumer peer. It is noted that the quantifying function in respect of the actual credit value may vary from peer to peer.

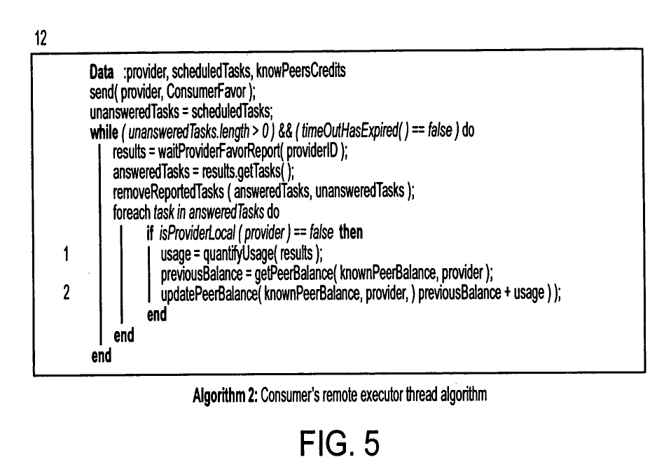

The consumer process can be described in a similar manner with reference to FIG. 5.

The consumer runs three threads: the requestor, the listener and the remote executor. The requestor is responsible for broadcasting client requests it receives as ConsumerQuery messages. After the ConsumerQuery for a given ClientRequest message has been sent, the consumer listener thread starts waiting for responses. It receives all the ProviderWorkRequest messages sent to the peer, notifying that the resources are available to the client as they arrive.

As shown in FIG. 5, each instance of the remote executor thread is responsible for sending a set of tasks to a provider, waiting for the corresponding responses and updating the balance of this provider in the local peer. The quantification is shown at line 1, the specifics of which may vary from peer to peer. The providers balance is updated at line 2 whereby the usage is added to the providers balance while it is deducted from the provider's executor.

It can be seen that the invention allows users of BoT applications to easily obtain access to, and use, grid-based computational resources. This can be done dynamically, thereby constituting an on-demand large-scale grid.

Given the approach of the network or favours, it is considered that the invention is capable of immediate implementation and deployment using present infrastructure. The invention operates in a completely decentralized manner which is crucial in terms of keeping the specifics of any implementation simple and scalable. Preliminary prototypes have shown that the network of favours approach is extremely promising and it is considered that any present implementation would be able to satisfy many of the present needs of computation-grid users at the present time.

It is further envisaged that the invention is not solely restricted to grid computing. One skilled in the art could implement the ‘network of favours’ approach of the invention in other distributed computing contexts such as network storage etc. In the case of network storage, unused storage behaves like an evanescent resource which may be offered according to the prioritized favour approach described above.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of allocating grid-based computer resources based on an exchange model exclusively of returned favours.

2. A method as claimed in claim 1, wherein a favour is defined as the act of offering a resource.

3. A method as claimed in claim 1, wherein the method is performed in respect of two or more grid resource providers/consumers, alternatively known as participants.

4. A method as claimed in claim 1, wherein the method comprises the steps of:
establishing two or more participants in a grid-based computer system, at least one of said participants offering resources; wherein, each participant expects resources to be offered in return in proportion to the level of resources which that participant offers.

5. A method as claimed in claim 1, wherein each participant benefits in proportion to the number of favours it provides to other participants.

6. A method as claimed in claim 1, wherein a participant offering resources arbitrates conflicting requests for that participants' resources by prioritizing requests from those other participants who have offered favours in the past.

7. A method as claimed in 6, wherein the step of request prioritization is performed subject to local policies.

8. A method as claimed in claim 7, wherein the policies are governed by characteristics of the participant offering the resources.

9. A method as claimed in claims 6, wherein the process of requesting a resources comprises the steps of a consumer making a request for resources by broadcasting to a peer-to-peer network the characteristics of the desired resources which correspond to the task to be executed; providers with matching and available resources replying to the requestor, potentially in accordance with local policies of the provider, wherein the set of replies from the providers constitute the grid which is thereby made available in response to the consumers request.

10. A method as claimed in claim 3, wherein a participant corresponds to a group of discrete participants logically aggregated for the purpose of offering specified resources.

11. A method as claimed in claim 10, wherein the aggregation is imposed by factors such as physical collocation, administrative control of the discrete participants, homogeneity in participant capability and the like.

12. A method as claimed in claim 3, wherein the participants correspond to peers in a peer-to-peer network.

13. A method as claimed in claim 12, wherein each peer maintains a record of the resources previously offered by each other known peer, thereby allowing each peer to prioritise other known peers when arbitrating conflicting requests for resources.

14. A method as claimed in claim 13, wherein each peer prioritizes peers who have provided favours in the past and marginalises peers who do not return favours.

15. A method as claimed in claim 1, wherein any available and idle resources are available to any user where there is no contention for those resources.

16. A method as claimed in claim 1, wherein the grid-based computer resource corresponds to computation cycles.

17. A method as claimed in claim 1, wherein the grid-based computer resource is network storage.

18. A network comprising a plurality of peers, each peer configured to offer and/or consume grid-based computer resources based on an exchange model exclusively of returned favours.

19. A network as claimed in claim 16, wherein each peer interacts with grid resources by means of a client wherein the client manages access to, and the execution of tasks on, the grid resources.

20. A computer configured to operate as a peer in accordance with the method as claimed in claim 1.
